(19) United States
(12) Patent Application Publication
(10) Pub. No.: US 2026/0202142 A1
(43) Pub. Date: Jul. 16, 2026

(54) HEAT STORAGE CONTAINER

(71) Applicant: VITAL ENERGI SOLUTIONS LIMITED, Blackburn Lancashire (GB)

(72) Inventors: Yulong DING, Edgbaston (GB); Mengqi BAI, Edgbaston (GB); Song YANG, Edgbaston (GB); Benjamin GREGOIRE, Edgbaston (GB); Tongtong ZHANG, Edgbaston (GB)

(21) Appl. No.: 18/870,136

(22) PCT Filed: Jul. 27, 2023
(86) PCT No.: PCT/EP2023/070912

§ 371 Date: Nov. 27, 2024

(30) Foreign Application Priority Data
Sep. 26, 2022 (GB) 2214034.7

(51) Int. Cl. F28D 20/02; F28D 20/00

(52) U.S. Cl. CPC F28D 20/028; F28D 2020/0026

(57) ABSTRACT

A thermal energy storage container comprising a chamber defined by at least one sidewall, a first end plate and a second end plate, the chamber comprising: at least one fluid inlet, at least one fluid outlet, a flow path for the transport of a heat transfer fluid, e.g. air, from the fluid inlet to the fluid outlet, and a support configured to support a receptacle within the flow path and enable direct contact between the heat transfer fluid, e.g. air, and a surface of the receptacle.

This invention relates generally to a heat storage container and a mobile thermal energy storage system comprising the heat storage container.

It is known to recover waste heat, for example industrial waste heat (IWH) from industries, and to generate renewable heat (RH), for example using wind and solar farms, and transport the heat to areas of demand. Such areas are usually located at a certain distance from the IWH and RH sources. One of the most popular technologies for recovering and transporting the IWH and RH is the so-called mobile thermal energy storage (M-TES) system (see Thermal energy storage (TES) for industrial waste heat (IWH) recovery: A review. Applied Energy. 2016; 179:284-301). The M-TES system is a high thermal energy-density transportation method which can be used to meet the heating demand of distributed users directly or can be combined with other heat supply systems, reducing both the consumption of fossil-fuel for heat generation and the emission of greenhouse gases and other pollutants (see A state-of-the-art review of the application of phase change materials (PCM) in Mobilized-Thermal Energy Storage (M-TES) for recovering low-temperature industrial waste heat (IWH) for distributed heat supply. Renewable Energy. 2021; 168:1040-57).

The M-TES contains thermal energy storage (TES) materials. Such TES materials can be classified into sensible, latent, and thermochemical categories. M-TES normally use latent heat storage materials, which are commonly known as phase change materials (PCMs), due to their high energy density and simple system designs. Traditional designs of M-TES systems are usually based on indirect-contact types of heat exchangers in which PCMs are encapsulated in tubes, boxes, shells etc. The encapsulated type systems are designed to further enhance the heat transfer performance by increasing the specific heat transfer surface area and introducing forced convection. However, drawbacks associated with such containers include leakage of molten PCM and liquid heat transfer fluid (HTF), and long charging/discharging times. The leakage of both PCM and HTF could produce safety concerns and loss of life has been reported in the past.

Existing PCM based M-TES technologies use PCMs such as erythritol, sodium acetate trihydrate, magnesium chloride hexahydrate and D-mannitol. Even though these PCMs provide a latent heat >100 J/g, they have a relatively low working temperature, less than 200° C., which not only limits the temperature range, but also the overall energy density of the TES system, which is critical for the M-TES system.

Further, the low thermal conductivity of most non-metallic PCMs (0.4-0.7 W/(m·K)) (see Performance enhancement in latent heat thermal storage system: A review. Renewable and Sustainable Energy Reviews. 2009; 13:2225-44) results in not only slow charging and discharging kinetics of the TES system, but also energy grade degradation due to dispersed temperature front during the charging/discharging processes.

It is therefore a first non-exclusive object of the invention to provide a heat storage container and a mobile thermal energy storage system which overcomes one or more drawbacks of the prior art.

Accordingly, a first aspect of the invention provides a thermal energy storage container comprising a chamber defined by at least one sidewall, a first end plate and a second end plate, the chamber comprising: at least one fluid inlet, at least one fluid outlet, a flow path for the transport of a heat transfer fluid (HTF) from the fluid inlet to the fluid outlet, and a support configured to support a receptacle within the flow path and enable direct contact between the HTF and a surface of the receptacle.

The receptacle may be for containing a material for thermal energy storage, such as a phase change material or a composite phase change material.

Advantageously, the container of the invention allows for portable heating, i.e. the container can be delivered directly to a required location, e.g., home, restaurant, convenience store, offices, classroom, stadium, temporary festival site etc., as a portable heater.

The thermal energy storage chamber may comprise a plurality of supports configured to support a plurality of receptacles in an array within the flow path and enable direct contact between the HTF and a surface of each receptacle.

The HTF may be a gas, for example carbon dioxide, nitrogen, helium, argon, air, (e.g. humid or dry air), or a combination thereof. Preferably, the HTF is air. Compared to the conventional liquid HTFs, such as heat transfer oils, air is much cheaper and easier to obtain, and able to work at a much higher temperature with a lower pressure drop. Advantageously, the use of air (e.g. recirculated air) to charge the M-TES container can greatly reduce the cost and mass of HTF, improve the safety and increase the overall efficiency.

The chamber may comprise multiple fluid inlets and/or multiple fluid outlets, e.g. at least 2, 3, 4, 5, 6, 7 or at least 8 fluid inlets and/or fluid outlets. The multiple fluid inlets and/or fluid outlets may enable multi-heat-source charging and/or multi-end-user discharging.

The chamber may comprise one or more baffles. The chamber may comprise one, two, three, four, five, six, seven, eight, nine, ten or more baffles. The one or more baffles may define a plurality of interconnected channels or zones. The plurality of interconnected channels or zones may be arranged in series and/or parallel to form the flow path.

Advantageously, the chamber of the invention has a simple, stable and compact structure. More advantageously, the chamber can greatly extend the flow path for heat transfer and thus increase the effectiveness of the heat transfer.

In use, the HTF, e.g. gas, for example air, may flow from the fluid inlet, through the flow path, e.g. the interconnected channels or zones, to the fluid outlet.

In an embodiment, the chamber comprises two baffles. The two baffles may be arranged perpendicular to one another, so as to divide the chamber into four channels or zones, e.g. lower left, upper left, upper right, and lower right channels or zones.

In an embodiment, the HTF, e.g. air, flows from the fluid inlet to the fluid outlet via lower left, upper left, upper right and lower right zones, in series, during charging.

Where more than one baffle is present, the baffles may be joined together, e.g. welded together.

The one or more baffles may comprise apertures. The apertures may receive one or more of the supports therethrough. For example, each aperture may receive a support therethrough.

The chamber may be any suitable shape. For example, the chamber may be cylindrical, being defined by a single continuous sidewall, a first end plate and a second end plate. Alternatively, the chamber may be rectangular or cuboidal, being defined by four sidewalls, a first (e.g. bottom) end plate and a second (e.g. top) end plate.

The or each support may be configured to removably receive the or each receptacle thereon.

The support(s) may be configured to enable direct contact between the HTF and at least 2, 3, 4 or 5 surfaces of the or each receptacle, when received in the chamber.

The or each support may be configured so as to enable direct contact between the HTF and at least 20% of the surface area of the or each receptacle, e.g. at least 20, 25, 30, 35, 40, 45, 50, 55, 60, 65, 70, 75, 80, 85, 90 or at least 95% of the surface area of the or each receptacle. For example, the or each support may be configured so as to enable direct contact between the HTF and from 20 to 100% of the surface area of the or each receptacle, e.g. from 20, 25, 30, 35, 40, 45, 50, 55, 60, 65, 70, 75, 80, 85, 90 or 95% to 25, 30, 35, 40, 45, 50, 55, 60, 65, 70, 75, 80, 85, 90, 95, or 100% of the surface area of the or each receptacle.

The plurality of supports may be configured such that the plurality of receptacles, when received in the chamber, can be arranged in a staggered configuration. The staggered configuration advantageously generates a turbulent flow of the HTF, thereby enhancing heat transfer.

As used herein, the term “staggered” will be understood that at least some of the receptacles, when received on the supports, are not aligned with (e.g. are vertically and/or horizontally offset from) each of their neighbouring receptacles. For example, one or more, or each, receptacle may be supported at a higher or lower position, relative to an adjacent receptacle.

In some embodiments, the plurality of supports may be configured such that receptacles can be arranged in groups or sets. For example, it may be that when maximum number of receptacles is received with the container, the receptacles are arranged in groups or sets. The supports may be configured such that the receptacles within each group or set are arranged one above the other. For example, the supports may be configured such that the receptacles within each group or set are vertically aligned. The supports may be configured such that the groups or sets are arranged side by side within the chamber. Each group or set may be staggered (i.e. vertically offset) relative to the adjacent group or set.

The plurality of supports may be configured such that the receptacles, when received in the chamber, are spaced apart from: each other, one or more of the at least one sidewall(s), the first end plate and/or the second end plate of the chamber. Spacing the receptacles apart from each other and/or the walls of the chamber enables flow of the HTF around the receptacles, thereby maximising heat transfer.

Each support may comprise or consist of a bar. In some embodiments, the container comprises a plurality of bars. Each receptacle may be supported by at least one bar, e.g. at least two bars. The use of bars, particularly narrow bars, to support the receptacle(s) maximises the surface area of the receptacle(s) which is exposed to the HTF, thereby improving heat transfer. The bar(s) may be of any suitable cross-section, for example circular, square, rectangular, L-shaped or substantially planar.

The support(s) may extend from an interior surface of one sidewall to an interior surface of an opposing sidewall. Additionally or alternatively, the support(s) may extend from an interior surface of the first plate to an interior surface of the second plate. In some embodiments, the support(s) may extend between the baffle(s) and the sidewall(s), and/or between the baffle(s) and first and/or second end plates. The support(s) may extend through the apertures located in the baffle(s).

One or more of the supports may extend in parallel with the flow path. One or more of the supports may extend perpendicular to the flow path.

The plurality of supports may be configured such that the receptacles (where present) may be distributed substantially evenly within the flow path. For example, the supports may be configured such that the receptacles (where present) are divided evenly between the channels or zones of the flow path.

A portion of the chamber, e.g. a portion of the chamber between the channels or zones of the flow path (e.g. a portion which connects one channel or zone with the next channel or zone), may be free from supports. That is, a portion of the chamber, e.g. a portion of the chamber between the channels or zones of the flow path, may be free from receptacles. Advantageously, where the portion of the chamber is free from supports and/or receptacles, the HTF can flow unobstructed along the flow path, e.g. between channels or zones of the flow path.

One or more of the sidewall(s) and/or end plates of the chamber may comprise an opening or a plurality of openings, e.g. elongate opening(s), for receiving the or each receptacle therein. The opening(s) may be arranged in a staggered array. The number of openings may correspond to the maximum number of receptacles which can be received within the chamber, when in use. The position of each of the openings may correspond to the position of the support(s), i.e. the or each opening may allow for a receptacle to be received within the chamber, such that the receptacle is located on one or more of the supports. It will be understood that the size and shape of each opening will be configured as appropriate for receiving a receptacle therethrough.

Each receptacle may be provided with a flange or a tab or another fixing means which is configured for securing the receptacle to the chamber, for example by bolts or screws.

In some embodiments, each receptacle may comprise a face plate which is configured to close the opening in the sidewall of the chamber when the receptacle is received in the chamber, i.e. when the receptacle is inserted through the opening and located on the support(s). The face plate may comprise or constitute the tab, flange or other fixing means for securing the receptacle to the chamber. For example, the face plate may be larger in at least one dimension than the opening in the chamber sidewall, such that when the receptacle is inserted into the opening, a portion of the face plate abuts an exterior of the sidewall of the chamber, and can be affixed/is securable thereto.

The chamber and/or the support(s) may be configured to receive at least 1 receptacle, e.g. at least 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 250, 300, 350, 400, 450 or at least 500 receptacles.

The fluid inlet and/or the fluid outlet may be provided on a first sidewall of the chamber. The fluid inlet and/or the fluid outlet may extend, e.g. protrude, from the first sidewall of the chamber.

The fluid inlet and/or the fluid outlet may comprise a reducer and/or a pipe, such as a nominal bore pipe e.g. a SCH10 nominal bore (NB) pipe. A flange, e.g. an ANSI RF slip-on flange, may further be provided at a terminus of the pipe. The flange may facilitate connection to a further pipe. The fluid inlet and/or the fluid outlet, e.g. the reducers forming the fluid inlet and/or the fluid outlet, may be the same size as each other.

A further aspect of the invention provides a receptacle for containing a material for thermal energy storage, the receptacle comprising a body, wherein a side or end portion of the body comprises a flange, a tab or a fixing means for securing the receptacle to a chamber, e.g. a chamber of the thermal energy storage container defined herein.

In use, when the receptacle is inserted into an opening in the chamber, a portion of the flange, tab or fixing means may contact (e.g. abut) an exterior of the sidewall of the chamber and is securable thereto.

Advantageously, the flange, tab or fixing means or a portion thereof allows for securing and positioning of the receptacle within the chamber.

The receptacle may be releasably secured to the chamber. Advantageously, this allows for removal of the receptacle and therefore allows for easy repair and/or maintenance of the receptacle(s) and chamber.

In embodiments, the flange or tab or fixing means is defined by or comprised within a face plate. The body and the flange, or tab or fixing means, e.g. the face plate, may be formed as a single unitary structure, or they may be formed as separate parts which are joined, e.g. welded together.

In an embodiment the flange or tab or fixing means, e.g. the face plate, may be greater in at least one dimension, e.g. wider and/or taller, than the body of the receptacle such that when the receptacle is inserted into an opening in a sidewall of the chamber, the body is received through the opening, into the chamber, but the flange or tab or fixing means, e.g. the face plate, abuts an exterior of the sidewall of the chamber and is securable thereto.

In some embodiments, the receptacle comprises a face plate which is configured to close the opening of the chamber e.g. the chamber of the thermal energy storage container defined herein, when the receptacle is received within the chamber. Advantageously, when the face plate closes the opening of the chamber it mitigates leaks of the HTF (e.g. air) and increases air tightness.

In some embodiments, the body of the receptacle, for example a side and/or end portion of the body, e.g. the face plate, may comprise one or more holes. The hole(s) may be between 0.1 and 0.5 mm in diameter. The hole(s) may be for receiving one or more probes, for example a thermocouple probe for measuring the temperature inside the receptacle, e.g. the temperature of the material for thermal energy storage.

The receptacle may comprise a lid. The lid may be openable to allow access to the interior of the receptacle.

Advantageously, the receptacle of the invention allows for easy loading and/or unloading of the contents of the receptacle.

The receptacle may be formed of any suitable material. In some embodiments, the receptacle is formed from a metal, e.g. stainless steel.

The receptacle, or a portion thereof, e.g. a side and/or end portion of the body, the face plate and/or the lid, may be thermally insulated. For example, at least an interior of the lid and/or the face plate of the receptacle may be thermally insulated. In some embodiments, all interior surfaces (i.e. the interior surfaces of the side walls, end portion(s) and lid, if present) of the receptacle are thermally insulated. In some embodiments, only the portions of the receptacle which are exposed to the outside air (i.e. exposed to the exterior of the chamber) are thermally insulated and the portions of the receptacle which are exposed to the inside of the chamber are not thermally insulated.

The receptacle may further comprise a handle. The handle may be in the form of a folded tab. The handle may protrude from an exterior surface of the receptacle, e.g. an exterior surface of the flange or tab or fixing means. In some embodiments, the handle protrudes from an exterior surface of the face plate.

The material for thermal energy storage (also referred to herein as a “thermal energy storage material”) may be a PCM or a CPCM. Thus, the receptacle may have a PCM or composite phase change material (CPCM) located therein.

Suitable PCMs and CPCMs will be known to those skilled in the art. For example, the PCM or CPCM may be a PCM or CPCM as disclosed by Orozco, M. A. et al., Materials 2021, 14, 7223; Ruguang et al., Materials & Designs, 104, 15 Aug. 2016, Pages 190-196; M. M. Kenisarin, Renewable and Sustainable Energy Reviews 14, 2010, 955-970; J. Pereira da Cunha, P. Eames, Applied Energy 177, 2016, 227-238; and Z. Jiang et al., Renewable and Sustainable Energy Reviews 159, 2022, 112134.

The formulations of PCM or CPCM, may be selected such that they operate in the range 50 to 1200° C., e.g. 100 to 1000° C., 200 to 800° C. or 300 to 500° C.

The CPCM may comprise a PCM, a structural material and a thermal conductivity enhancer material.

The PCM or CPCM may be in the form of a module, e.g. a brick.

The PCM or CPCM may comprise one or more inorganic compounds, one or more organic compounds, salts or mixtures thereof.

In some embodiments, the PCM or CPCM may comprise a mixture of inorganic compounds, e.g. inorganic salt mixtures.

Advantageously, the PCM/CPCM relies on both solid-liquid and solid-solid transitions, further increasing the energy storage density.

The CPCM may comprise a structural material, e.g. a ceramic skeleton material. The structural material, e.g. ceramic skeleton material, may be selected from: heavy magnesium oxide, light magnesium oxide, silica, alumina, vermiculite, diatomite or other suitable structural materials or combinations thereof

Preferably, the structural material, e.g. ceramic skeleton material, is heavy magnesium oxide, light magnesium oxide or vermiculite.

Advantageously, the structural material, e.g. ceramic skeleton material, provides a strong supporting structure for shape stabilisation of the CPCM. Further, the structural material prevents deformation of the CPCM and helps holding the particles during shaping and compacting of the CPCM mixture into a module. It also prevents the occurrence of leakage due to the repeated solid-liquid transition cycles during operation of the M-TES system.

The CPCM may comprise a thermal conductivity enhancer material, e.g. an organic or an inorganic compound with high thermal conductivity and thermal stability in the operating temperature range.

Preferably, the thermal conductivity enhancer material is expanded graphite.

Advantageously, the thermal conductivity enhancer material increases the thermal conductivity of the CPCM, which improves the heat transfer efficiency during charging/discharging cycles. Further, the presence of the thermal conductivity enhancer material may reduce the charging time so that the total energy stored by the M-TES system after 6 hours of charging is at least 250 MJ.

The PCM or CPCM may be shaped and/or compacted into modules (e.g. bricks) according to the size and/or shape of the receptacle. Advantageously, this ensures that there is no leakage during operation.

The receptacle may contain graphite powder which may coat at least a portion of an interior surface of the receptacle. This may further enhance heat transfer and/or may help to protect the material contained therein (i.e. the material for thermal energy storage) from corrosion.

The PCM or CPCM, e.g. a PCM or CPCM module, may be wrapped and/or sealed in a foil. The foil may be a stainless steel or aluminium foil. The PCM or CPCM may be wrapped and/or sealed in the foil prior to loading in the receptacle. The foil may further increase the heat transfer efficiency between the walls of the receptacle and the PCM or CPCM. The foil may also contain the PCM/CPCM in case of leakage and help to protect the materials from molten salt corrosion. Further, a surface of the foil may be at least partially coated with graphite powder.

Methods of manufacturing PCMs and CPCMs will be known to a person skilled in the art, for example as disclosed in Orozco, M. A. et al., Materials 2021, 14, 7223; Ruguang et al., Materials & Designs, 104, 15 Aug. 2016, Pages 190-196; Ge et al. (2014) Particuology, Volume 15, Pages 2-8; and Navarro et al. (2020) Chapter 7 in Book ‘Thermal Energy Storage: Materials, Devices, Systems and Applications, edited by Ding Y.

A further aspect of the invention provides a thermal energy storage system for storing, transporting and utilising renewable heat, waste heat, or heat produced with off-peak electricity, the thermal energy storage system comprising a thermal energy storage container as described herein.

Advantageously, the thermal energy storage system allows for portable heating, i.e. the thermal energy storage container can be delivered directly to a required location, e.g., home, restaurant, convenience store, offices, classroom, stadium, outdoor festival venues etc., as a portable heater.

The thermal energy storage system may further comprise one or more receptacles. For example, at least 1 receptacles, e.g. at least 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 250, 300, 350, 400, 450 or 500 receptacles. The one or more receptacles may be a receptacle as described herein. For example, the one or more receptacles may comprise a PCM or CPCM as detailed herein.

The one or more receptacles may be arranged in a staggered array within the chamber.

The one or more receptacles may be spaced apart from one another and/or the walls, e.g. the bottom plate, top plate and one or more of the sidewalls, of the chamber. The minimum distance between the receptacles may be in the range 5 to 100 mm, e.g. 5, 10, 15, 20, 25, 30, 35, 40, 45, 50, 55, 60, 65, 70, 75, 80, 85, 90, 95 or 100 mm. The minimum distance between the receptacles and the bottom and top plates of the chamber may be in the range 5 to 50 mm, e.g. 5, 10, 15, 20, 25, 30, 35, 40, 45 or 50 mm. The minimum distance between the receptacles and one or more of the sidewalls of the chamber may be in the range 2 to 200 mm, e.g. 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195 or 200 mm. Advantageously, this allows for heat transfer enhancement through the creation of heat transfer surface area, the generation of turbulent flow and the breaking of boundary layers.

The one or more receptacles may be detachably mounted within the chamber. That is, the one or more receptacles may be removable, from the chamber. Each receptacle may be removed from the chamber via the openings in the chamber.

In use, the one or more receptacles can be slid in and/or out of the chamber, through the openings, like a drawer. The one or more receptacles may be configured to be removably secured within the chamber. The one or more receptacles may be secured or fastened, e.g. removably secured or fastened, to the chamber using fasteners or fastening means, e.g. screw, nuts, bolts, bars, flanges, frames etc.

Advantageously, the invention allows for independent loading and unloading of each receptacle within the chamber.

Advantageously, the provision of detachably mountable receptacles improves the performance, compatibility and flexibility of the container. The container is therefore easier to maintain as its construction allows for targeted repair and replacement of components, as well as for thermal energy takeaways services.

The openings, e.g. elongate openings, in the sidewalls of the chamber will be suitably sized for receiving the receptacles therethrough. The openings may be larger in area than e.g. taller and/or wider than, the body of the receptacles.

The openings in the sidewalls of the chamber may be sized such that the flange, tab or fixing means (e.g. face plate) of the receptacles cannot pass therethrough. That is, in use the body of each receptacle may be inserted through one of the openings, e.g. elongate openings, until the flange or tab or fixing means, e.g. the face plate, abuts an exterior of the sidewall of the chamber.

Where the receptacle comprises a face plate, the face plate of the receptacle may be configured such that it is greater in dimension than the opening in the sidewall of the chamber, such that when a receptacle is inserted into an opening, a portion of the face plate abuts an exterior of the sidewall of the chamber and is securable thereto.

When receptacles are received within each of the openings, i.e. such that there is no free opening, an air-tight system may be formed.

In some embodiments, the thermal energy storage system comprises one or more heat exchangers. The one or more heat exchangers may be for charging and/or discharging HTF to and/or from the thermal energy storage container, in use.

The one or more heat exchangers may further comprise one or more process lines, e.g. pipes and/or hoses. The pipes may be metal (e.g. stainless steel) pipes. The hose may be a flexible hose. The one or more process lines, e.g. the pipes and/or hoses, may be welded together and/or joined by flange connections. The one or more process lines, e.g. the pipes and/or hoses, may be thermally insulated.

The one or more process lines, e.g. the pipes and/or hoses, may comprise one or more (e.g. a plurality of) supporting legs and/or feet. The supporting legs and/or feet may be attached (e.g. welded) onto the process lines. This means that the process lines can be secured, e.g. bolted, to the floor of a carrier, for example during transportation. Each supporting leg may be spaced apart from each other supporting leg by an interval of from 100 to 1000 mm, e.g. 100, 200, 300, 400 500, 600, 700, 800, 900 or 1000 mm. The height of the supporting legs may be consistent with the height of the chamber. Preferably, the contact area between the supporting feet and the carrier floor is minimised, to reduce heat loss.

The fluid inlet and/or the fluid outlet may be configured for attachment to one or more heat exchangers. Advantageously, the thermal energy storage system allows for off-site industrial waste heat recovery and renewable heat storage.

In some embodiments, the thermal energy storage system comprises an electrical heater. An electrical heater can be conveniently used for the conversion of off-peak electricity to heat. The heater may be an air heater cassette, e.g. a 24 KW air heater cassette. The heater may have a maximum temperature in the range 50 to 1200° C., e.g. 100, 150, 200, 250, 300, 350 400, 450, 500, 550, 600, 650, 700, 750, 800, 850, 900, 950, 1000, 1050, 1100, 1150 or 1200° C. That is, the heater may heat the recirculated air to a maximum temperature in the range 50 to 1200° C., e.g. 100, 150, 200, 250, 300, 350 400, 450, 500, 550, 600, 650, 700, 750, 800, 850, 900, 950, 1000, 1050, 1100, 1150 or 1200° C. The heater may be customized according to the requirements of the M-TES system. In an embodiment, the heater has six electricity connecting poles providing two sets of three-phase electricity supplies. In an embodiment, the heater has three electricity connecting poles providing one set of three-phase electricity supplies.

Advantageously, the thermal energy storage system may be capable of storing heat at up to 50, 100, 150, 200, 250, 300, 350, 400, 450, 500, 550, 600, 650, 700, 750, 800, 850, 900, 950, 1000, 1050, 1100, 1150 or 1200° C.

In some embodiments, the thermal energy storage system comprises one or more instruments e.g. one or more thermocouples and/or temperature controllers and/or one or more pressure transducers, for monitoring and/or controlling the temperature and/or pressure of the system.

The one or more temperature controllers, e.g. PID temperature controllers, may be for controlling the heater/heating power. Each electricity supply line may be connected to a temperature controller. The integrated relays inside the temperature controllers may be automatically turned on, adjusted and off to start, change the power input of, and pause the heating elements based on temperature feedback received to ensure that the outlet HTF temperature is at the setpoint. A thermocouple may be installed at the rear of the heater for real-time monitoring of the outlet air temperature.

The temperature controllers may be programmed to power the heater with 100% power when the process temperature is lower than the setpoint value and with reduced power when the temperature approaches the setpoint.

In some embodiments, the thermal energy storage system may comprise a blower. The blower may be a high-temperature air blower. The blower may circulate the HTF within the chamber and/or the system, in use. Hot HTF, e.g. air, may be circulated inside a closed loop by the blower. The blower may have a high temperature resistance and a maximum operating temperature in accordance with the maximum air temperature at the inlet. The blower may have a heat removal system to ensure the functioning of blower motor and associated accessories.

The heater may be able to produce two or more levels of heating power, e.g. at 0, 2, 4, 6, 8, 10, 12, 14, 16, 18, 20, 22, or 24 KW. Over-heating detected either at the heater outlet or at the blower inlet may lead the heater to operate on different levels, lower than full power. Over-heating at both feedback lines may result in a reduced number of or even full turn-off of all of the heating elements.

The instrumentation may further comprise a flow control valve. The flow control valve may be added into the loop, downstream of the blower outlet, to control the air flow rates to meet the charging and discharging rates while keeping the temperature and pressure at various positions within allowable range.

Alternatively, a variable frequency drive (e.g. Schneider Electric 3-Phase Variable Frequency Drive) may be used to precisely control the speed of a 3-phase motor and thus control the air flow rate.

The instrumentation may be used to monitor and control the heat charging and discharging processes quantitatively. The instrumentation may include thermocouples, e.g. type-K thermocouples, and/or high-temperature pressure transducers, for taking temperature and pressure measurements, respectively. The instrumentation may comprise one or more flowmeters, e.g. a Venturi tube based flowmeter. The Venturi flowmeter may be connected to a flow controller for flow rate measurements and flow control. The flow rate control may also be done through controlling the blower via e.g. power input to the blower.

The thermocouples may be installed at different locations within the system. A thermocouple may be located at the inlet of the blower, to avoid over-heating of the blower. Another thermocouple may be located at the heater's outlet to monitor the maximum air temperature generated. The thermocouples may comprise a measuring tip and a connection to a datalogger or PID temperature controller as feedback.

Socket weld thermowells may be used for installation of thermocouples onto the main process lines and to prevent the thermocouples from damage caused by thermal/hydraulic/acceleration stress.

The pressure transducers may be any that can take the process temperature, flow and pressure conditions, e.g. Gems pressure transducers. The pressure transducers may be installed at various locations in the loop. One or more pressure transducers may be located at the Venturi tube, for flowrate measurements; one or more pressure transducers may be located downstream of the heaters outlet; one or more pressure transducers may be located at the inlet and outlet of the blower; one or more pressure transducers may be located downstream of the flow control valve; one or more pressure transducers may be located at the heaters inlet.

The pressure transducers may be connected to the main flow pipeline with a small sized extended tube, via e.g. a female G1/4 connector, to avoid its temperature exceeding the upper temperature limit. Cooling coils may be attached to the extended tube, avoiding the need for expensive ultra-high-temperature pressure transducers.

An interception valve and/or a bleed valve may be installed for pressure transducer installation, calibration, and maintenance or replacement. The interception valve may be closed and the bleed valve opened during installation of the pressure transducer. The bleed valve may be closed and pressure applied and the interception valve slowly opened to ensure flow and the pressure readings are recorded by the datalogger.

In some embodiments, the thermal energy storage system comprises insulation. The insulation may surround one or more components of the thermal energy storage system, e.g. the chamber, heater, blower and/or process lines.

The insulation may comprise one or more layers of insulation materials e.g. non-ceramic Millboard thermal insulating sheets, flame retardant Superwool 607 Fibre, blanket-like insulation, insulation bricks, cast-able insulation materials, aerogel based insulation materials and the like. Different types of insulation materials may be used to reduce heat loss from various components such as the hot air chamber (HAC), heater, blower and process lines. For the main process lines, a blanket-like insulation may be used. In an embodiment an outer layer of Millboard thermal insulating sheet material may be used to enclose the entirety of the HAC and a “cotton wool puff” shaped inner layer of insulation may be provided to fill any gaps.

In some embodiments, the thermal energy storage system comprises a carrier for transporting one or more components of the thermal energy storage system or the components of a plurality of thermal energy storage systems. The carrier may be a vehicle, e.g. a truck, trailer, train, boat, etc. The components of the TES system may be secured, e.g. bolted, to a surface (e.g. floor) of the carrier, during transportation. The weight capacity of the carrier may be in the range of 0.1 and 50 tons, e.g. 0.1, . . . 2, 2.5, 3, 3.5, 4, 3.5, 6, 6.5, 7, 7.5, 8, . . . 50 tons. The carrier may be capable of supporting the weight of 3-4 persons, in addition to the components of the M-TES system(s). The carrier may be able to withstand over 1G acceleration in the vertical direction. Where the carrier is a trailer, it may be towed by a tractor or another vehicle with an appropriate power. The carrier may comprise a back and/or side panels which can be dropped-off to flat, to allow easy access to the components of the TES system on the carrier. The carrier may comprise a wind up and down landing foot to ensure steadiness and allow adjustment of height on the hitch side of the carrier.

Preferably, the chamber(s) and/or container(s) has a flat base, such that it can be easily loaded and/or transported on a carrier. Additionally or alternatively, the container(s) may comprise a frame, allowing the container(s) to be supported and/or fixed onto a carrier.

The container base may be designed to have sliding rail or wheels and the carrier may have a track. The container may be loaded onto the carrier using the wheel-track system or by sliding mechanisms, powered by e.g. pulley mechanisms.

In some embodiments, prior to use the PCM or CPCM modules may be prepared and loaded into the plurality of receptacles. For example, one module may be loaded into each receptacle. Next, the plurality of receptacles may be loaded into the chamber via the openings, and secured/fastened to the chamber via the flange or tab or fixing means, e.g. face plate, of the receptacle. The container, and optionally other components of the TES system, may then be loaded and secured on the carrier.

The carrier may be transported to the waste heat source or a site with a low-cost off-peak electricity supply or renewable energy site, or to an end user site. Prior to charging/discharging, the TES container or system may be unloaded from the carrier and assembled. One or more heat exchangers may be connected to the fluid inlet. One or more heat exchangers may be connected to the fluid outlet of the chamber. The one or more heat exchangers may be installed such that the TES container(s), comprising the PCM/CPCM, is connected to the heat source or end user site.

A further aspect of the invention provides the use of a thermal energy storage container, a receptacle or a thermal energy storage system as described herein for storing and/or transporting thermal energy.

The use may be of multiple containers and/or TES systems.

A further aspect of the invention provides a method of charging a thermal energy storage (TES) system, the method comprising:
providing a thermal energy storage system as described herein; wherein the chamber of the thermal energy storage container contains a plurality of receptacles having a material for storing thermal energy (e.g. a PCM or a CPCM) located therein;
flowing a heated HTF through the fluid inlet of the chamber, along the flow path and out of the fluid outlet, such that heat transfer takes place from the HTF to the receptacles, thereby charging the material (e.g. a PCM or a CPCM) therein.

The HTF may be any suitable fluid, e.g. a gas. For example, the HTF may be carbon dioxide, nitrogen, helium, air, (e.g. humid or dry air), or a combination thereof. Preferably, the HTF is air.

The method may further comprise installing the TES system.

The heat transfer fluid may have been heated by a heat source such as an industrial waste heat (IWH) site, a renewable energy source site, or waste energy from an industrial process. Alternatively, the HTF itself may be a waste product (e.g. waste gas) of an industrial process. Thus, in some embodiments the heat source is an industrial site (e.g. an industrial waste heat site).

Alternatively, the HTF may have been heated using a heater, such as an electrical heater. Using cheaper off-peak electricity or excess electricity may advantageously be used to charge the system economically. Thus, in some embodiments the heat source is a heater, such as an electrical heater.

In some embodiments, the method further comprises heating the HTF. The HTF may be heated using a heat source. The heat source may be a renewable energy generation site (e.g. wind farm, solar farm), an industrial site, such as an industrial waste heat (IWH) site, or it may be a heater, e.g. an electrical heater.

The method may further comprise transporting the TES system, or the container, to a heat source site, such as an industrial site (e.g. an industrial waste heat site).

In some embodiments, the method further comprises, after charging, transporting the HTF from the fluid outlet back to the heat source. The method may further comprise cooling the heat transfer fluid, e.g. air, as it is transported from the fluid outlet to the heat source. In this way, colder HTF which leaves the chamber can be re-heated by the heat source and circulated back to the TES to continue charging the PCM/CPCM. Advantageously, cooling the HTF avoids the blower from overheating.

The method may comprise heating the HTF from 50-400° C. to 200-1200° C., depending on applications.

The method of charging the TES system may be carried out for a period of several minutes to several hours, for example from 30 minutes to 20 hours.

The method may comprise driving the flow of the HTF along the flow path, for example by using a blower.

The method may comprise circulating the HTF at a constant or a varying volumetric flow rate.

The method may further comprise controlling the temperature of the HTF. The HTF may be cooled, as it is transported from the fluid outlet to the heat source. This may be achieved by introducing ambient fluid (e.g. ambient air) into the HTF, or through passing through another heat sink (e.g. another TES system).

The method may comprise transporting the TES system to an end user site, i.e. after step (b)/charging.

The method may further comprise discharging the TES system. Discharging may be carried out in accordance with the method described hereinbelow.

In a further aspect of the invention, there is provided a method of discharging an TES system, the method comprising:
providing a TES system as described herein; wherein the chamber of the thermal energy storage container contains a plurality of receptacles having a charged thermal energy storage material (e.g. a PCM or CPCM) located therein;
flowing a HTF through the fluid inlet of the chamber, along the flow path and out of the fluid outlet, such that heat transfer takes place from the receptacles to the HTF, thereby discharging the thermal energy storage material (e.g. PCM or CPCM) therein.

The method may comprise transferring the heated HTF from the fluid outlet to an end user.

The method of discharging may be discontinued when the temperature of the HTF at the fluid outlet drops below a pre-set temperature depending for applications. For example, for space heating applications, this pre-set temperature may be at 120° C., e.g. below 110, 100, 90, 80, 70, 60, 50 or 40° C.; for drying, steam generation or process heating applications, this pre-set temperature may be between 12° and 400° C.

The method may be carried out under ambient pressure.

The method may further comprise loading the components of the TES system onto the carrier. The method may further comprise transporting the carrier comprising the TES components back to the heat source, ready for the next operational cycle.

Accordingly, this invention concerns a novel thermal energy storage container and a thermal energy storage system (i.e. a mobile thermal energy storage system, M-TES) for renewable heat, off-peak electrical energy storage, industrial waste heat recovery and utilization for example in domestic heating, drying, steam generation, process heating, or other emergency heating services. The thermal energy storage container and thermal energy storage system display improved thermal performance, stability, compatibility, flexibility and are highly cost-effective compared to other latent heat mobile thermal storage systems.

It will be appreciated by those skilled in the art that any of the aspects or embodiments of the invention described herein may be combined with each other in any combination as appropriate, unless stated otherwise.

Embodiments of the invention will now be described by way of example only with reference to the accompanying drawings in which:

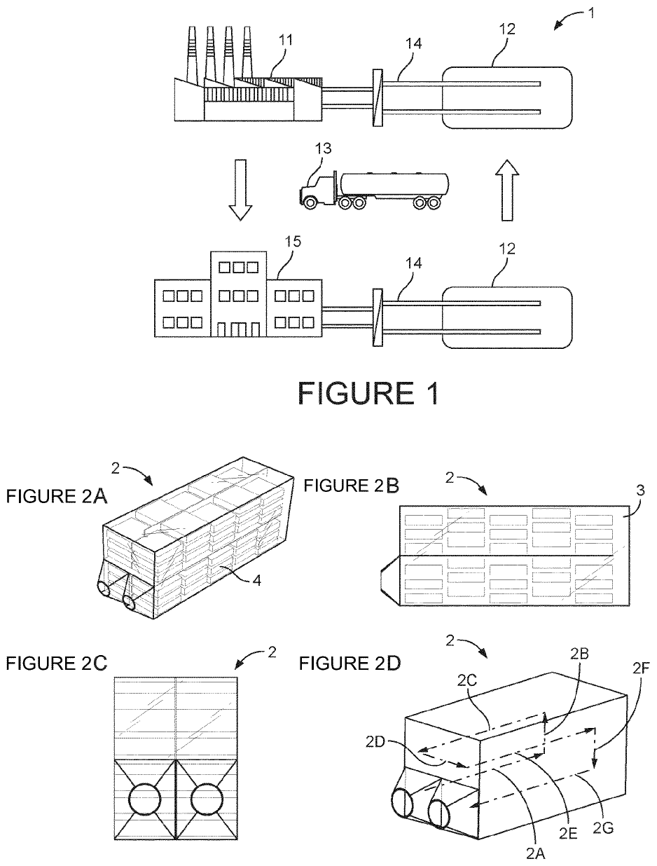

FIG. 1 is a general schematic of a M-TES system using an example for waste heat recovery and domestic heating supply;

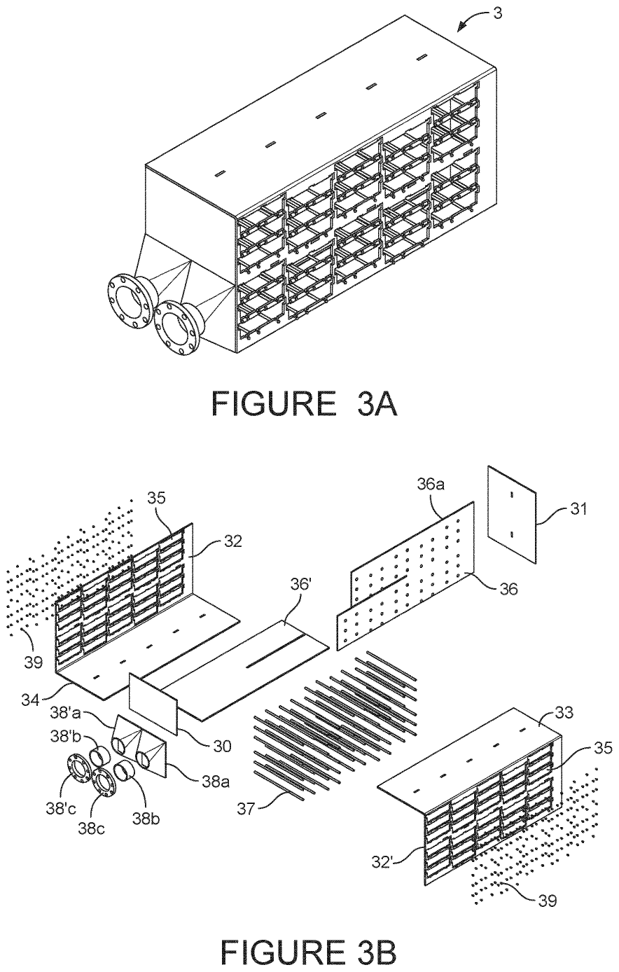

FIGS. 2A to 2D are schematics of a M-TES container according to an embodiment of the invention;

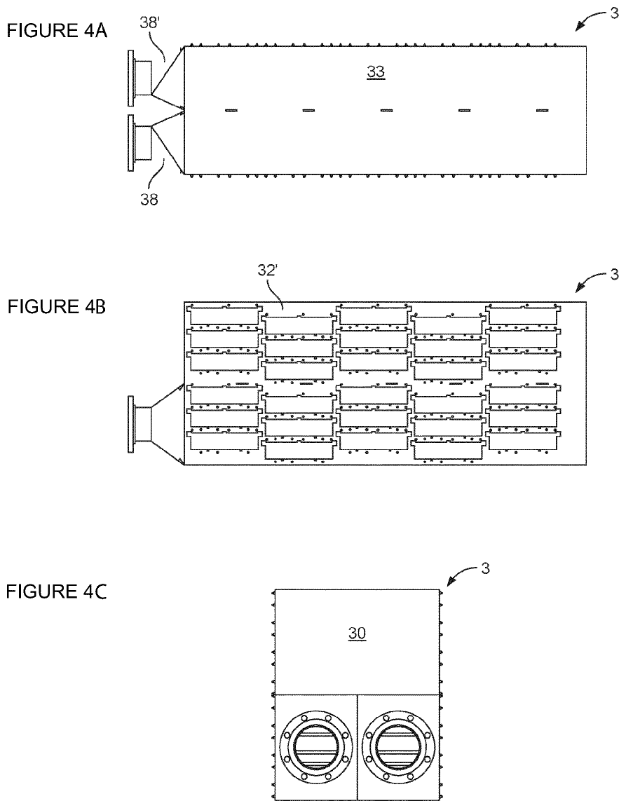

FIG. 3A is a perspective view of the hot air chamber of the M-TES container of FIG. 2;

FIG. 3B is an exploded view of the hot air chamber of FIG. 3A;

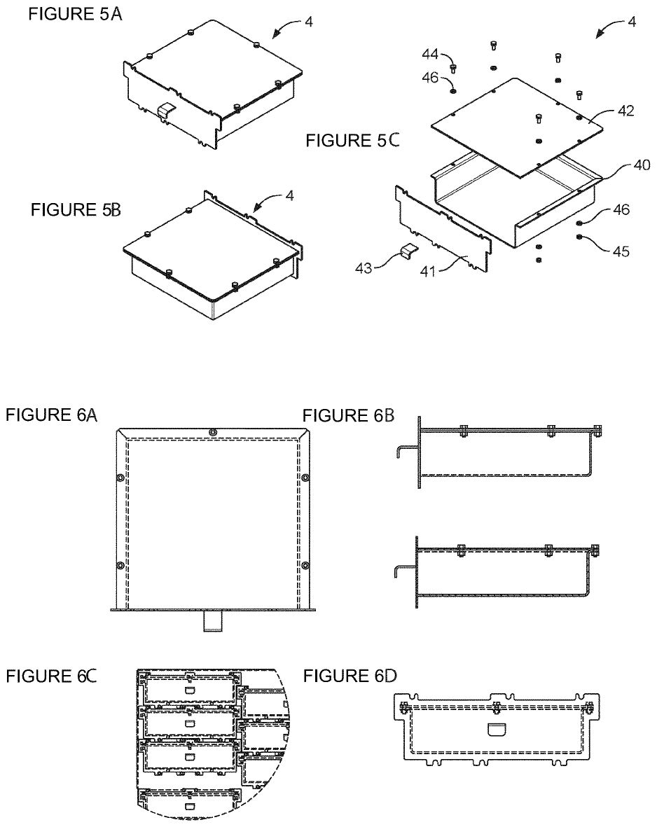

FIGS. 4A to 4C are schematics of the hot air chamber of FIG. 3 according to an embodiment of the invention;

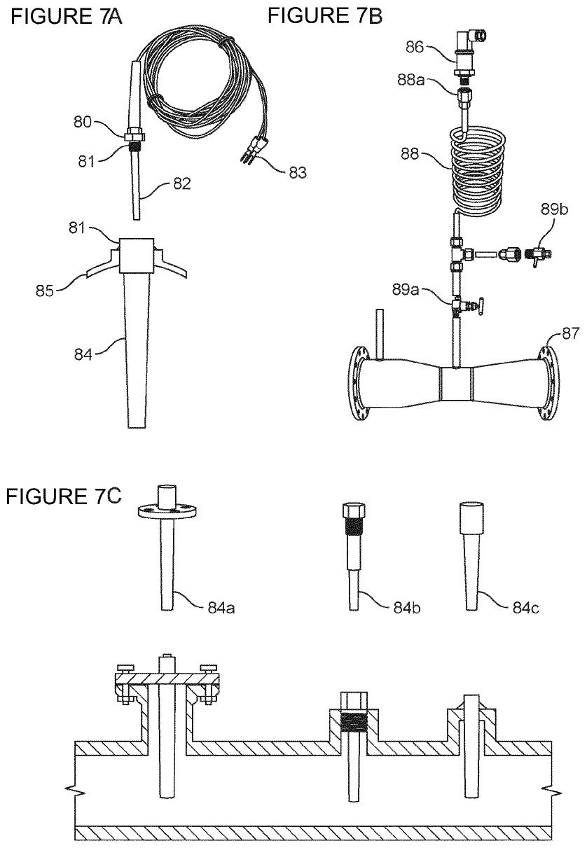

FIGS. 5A and 5B are perspective views of the detachable rectangular boxes (receptacles) of the M-TES container of FIG. 2;

FIG. 5C is an exploded view of the detachable rectangular boxes of FIG. 5A;

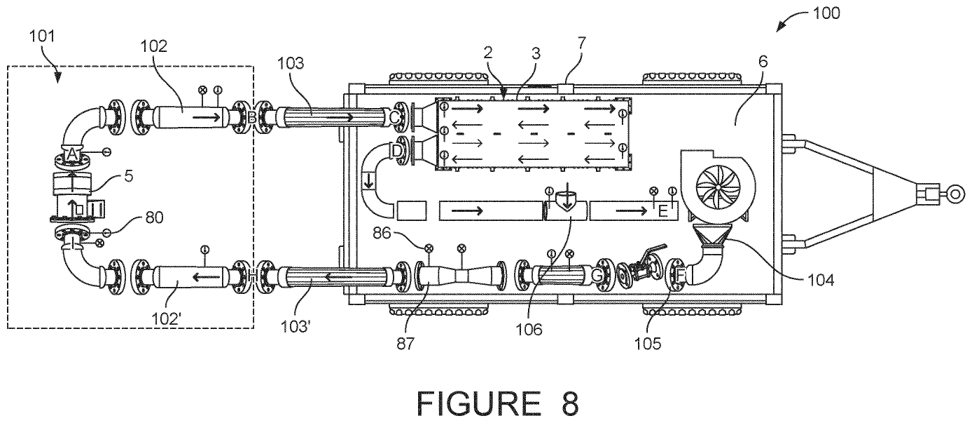

FIGS. 6A to 6D are schematics of the detachable rectangular boxes of FIG. 5 according to an embodiment of the invention;

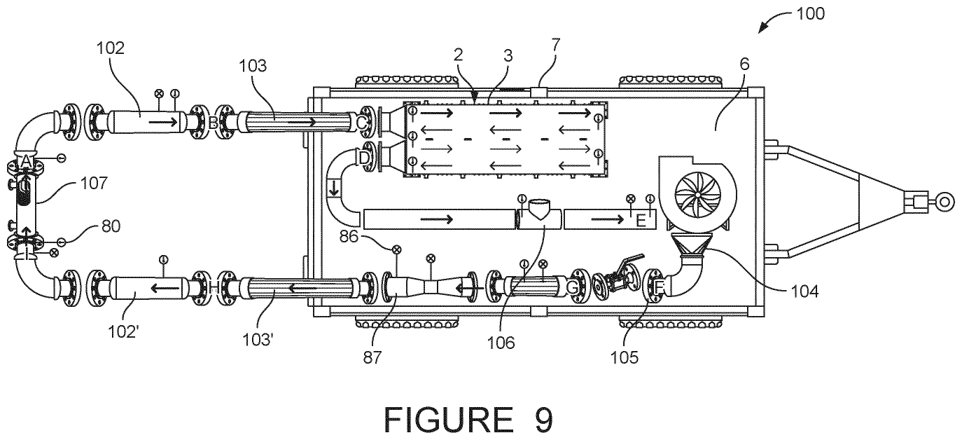

FIG. 7A is a schematic of a selected temperature measurement setup;

FIG. 7B is a schematic of selected pressure and flow rate measurement setup;

FIG. 7C is a schematic of three types of selected thermowell connections;

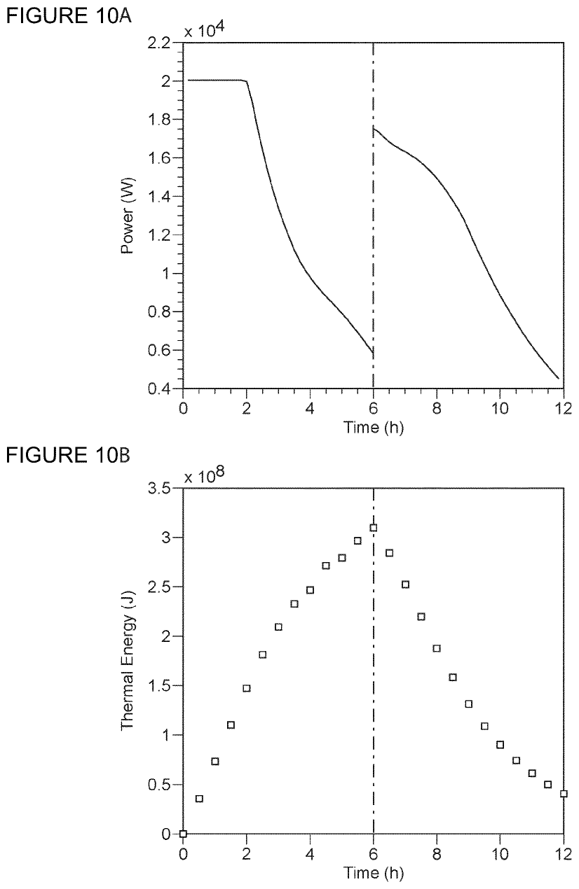

FIG. 8 is a schematic flow of the M-TES system for the charging phase according to an embodiment of the invention;

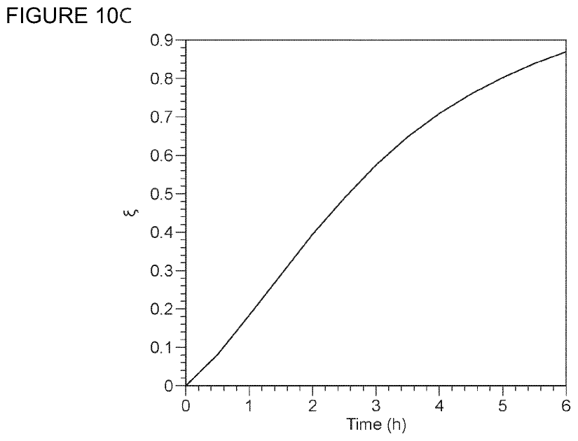

FIG. 9 is a schematic flow of the M-TES system for the discharging phase according to an embodiment of the invention;

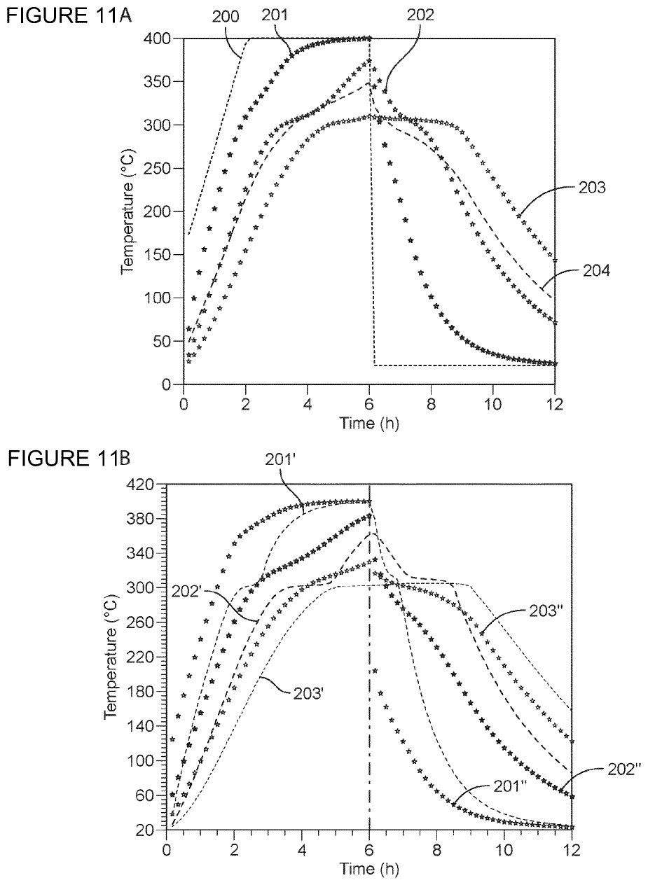

FIGS. 10A to 10C are graphs to illustrate, according to an embodiment of the invention, heating power, thermal energy during charging and discharging processes and proportion of released heat to total amount of stored heat during discharging;

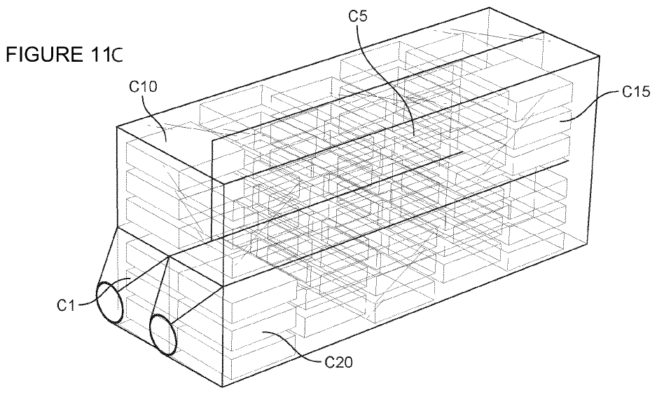

FIGS. 11A and 11B are graphs showing temperature evolution during a charging and discharging cycle according to an embodiment of the invention; and

FIG. 11C is a schematic showing an array of detachable rectangular boxes, arranged in columns.

FIG. 1 provides an overview of the overall concept of mobile thermal energy storage 1, which comprises a heat source site 11 (e.g. an IWH source site), a M-TES container 12, a carrier (e.g. a truck, train or boat) 13, heat exchangers 14 for charging and discharging at the heat source site 11 and a distributed end user site 15.³ During the charging process, the M-TES container 12 is transported to the heat source site 11 by the carrier 13 and the heat is transferred to a thermal energy storage material (e.g. PCM/CPCM modules, not shown) contained within the M-TES container 12. After the charging process, the M-TES container 12 is delivered to the distributed end user site 15 by the carrier 13 and the discharging process commences. The stored heat in the thermal energy storage material is released and the M-TES container 12 is transported back to the heat source site 11, ready for the next operational cycle.

Referring now to FIGS. 2A to 2C, there is shown perspective views (FIG. 2A), a side view (FIG. 2B) and a front view (FIG. 2C) of a M-TES container 2 according to the invention.

The M-TES container 2 comprises a hot air chamber (HAC) 3 and an array of sixty detachable rectangular boxes (DRBs) 4 (i.e. receptacles), which may be made of a suitable metal such as stainless steel.

The DRBs 4 comprise one or more PCM/CPCM modules (not shown) located therein. The DRBs 4 are fastened to the M-TES container 2 by fasteners (not shown), for example screws-nuts, bars, flanges and frames.

Referring now to FIG. 3, there is shown a perspective view (FIG. 3A) and an exploded view (FIG. 3B) of the HAC 3 of FIG. 2. The HAC 3 comprises a first sidewall 30, a second sidewall 31, a third sidewall 32, a fourth sidewall 32′, a first end plate 33 and a second end plate 34. Each of the end plates 33, 34 and each of the sidewalls 30, 31, 32, 32′ of this embodiment are 5 mm thick.

The first and second sidewalls 30, 31 are in parallel and opposing relations. The third and fourth sidewalls 32, 32′ are in parallel and opposing relations. Together the sidewalls form a rectangular arrangement.

In this embodiment the first end plate 33 and sidewall 32′ are formed as a single part. In this embodiment, the second end plate 34 and the side panel 32 are formed as a single part.

Each of the sidewalls 32, 32′ has 30 rectangular openings 35 for receiving the DRBs 4. The rectangular openings 35 are in a staggered arrangement.

The openings 35 are configured such that the receptacles when received therein are arranged in groups/sets. In each group/set, the openings are configured such that the receptacles may be arranged one above the other. In this embodiment, the openings are configured such that the receptacles will be aligned vertically in groups/sets of three. Each group/set is staggered (i.e. vertically offset) relative to the adjacent group/set.

The walls 30, 31, 32, 32′, 33 and 34 of the HAC 3 define an interior space. The interior space of the HAC 3 is equally divided into four interconnected air channels (illustrated in FIG. 2D) by a vertical baffle 36 and a horizontal baffle 36′. In this embodiment, the internal baffle walls 36, 36′ are stitch welded together. In this embodiment, the internal baffle walls 36, 36′ are approximately 5 mm thick.

Round bars 37 are extend between the sidewalls 32, 32′ of the HAC 3 to act as supports for the DRBs 4. The round bars 37 of this embodiment extend through apertures 36a located in the vertical baffle 36. In this embodiment, there are sixty round bars 37 for receiving sixty DRBs 4 in a staggered array. The round bars 37 of this embodiment have a diameter (Ø) of 10 mm and are 636.5 mm long.

In this embodiment, air is used as the HTF to charge and discharge the M-TES container 2. Two reducers 38a, 38′a combined with two SCH10 nominal bore (NB) pipes 38b, 38′b and two ANSI RF slip-on flanges 38c, 38′c are installed on the front of HAC 3 as the fluid inlet and fluid outlet 38′, 38. The reducers 38a, 38′a of this embodiment are 3 mm thick, the NB pipes 38b, 38′b have a circular diameter of 6 inches and are 100 mm long and the slip-on flanges 38c, 38′c have a circular diameter of 6 inches.

M6×10 mm Weld studs 39 are used to fix the DRBs 4 to the HAC 3. In this embodiment, 360 welded studs are used.

As shown in FIG. 2C, in use, the HTF enters the chamber 2 through the fluid inlet 38′. The HTF then flows along the first channel (Arrow 2A), before flowing upwards (Arrow 2B) and along the second channel (Arrow 2C). The HTF then passes from the second channel to the third channel (Arrow 2D). The HTF flows along the third channel (Arrow 2E) before flowing downwards (Arrow 2F) and along the fourth channel (Arrow 2G) before exiting the chamber at the fluid outlet 38.

Accordingly, the chamber 2 is free of receptacles at an end opposing the fluid inlet and fluid outlet, so as to allow the HTF to pass from the first channel to the second channel and from the third channel to the fourth channel.

As shown in FIG. 3B, the baffle 36 is shaped so as to allow the HTF to pass from the second channel to the third channel. That is, the baffle 36 is shorter than the sidewalls 32, 32′, creating a gap for the HTF to flow through.

The HAC 3 is shown in FIGS. 4A to 4C, wherein FIG. 4A is a top view, FIG. 4B is a side view and FIG. 4C is a front view. The dimension of the HAC including the reducers is 2060 mm (length)×690.5 mm (width)×836.9 mm (height). Two reducers 38a, 38′a, forming the fluid outlet and fluid inlet, are connected at the front panel 30 of the HAC 3, the sizes of which are 150 mm inner in diameter and 152 mm in length.

Referring now to FIG. 5, there are shown perspective views (FIGS. 5A and 5B) and an exploded view (FIG. 5C) of the detachable rectangular boxes (DRBs) 4 of FIG. 2. The DRBs serve as receptacles for containing a thermal energy storage material.

Each DRB 4 comprises a body 40. An end portion of the body 40 comprises a face plate 41. The receptacle further comprises a lid 42.

The face plate 41 comprises a folded tab 43 protruding from the external surface. The folded tab 43 acts as a handle such that the DRBs 4 can be slid in or taken out of the M-TES container 2.

Each of the body 40, face plate 41, lid 42 and folded tab 43 are 3 mm thick.

The body 40 and face plate 41 are welded together. In use, one of more PCM/CPCM modules are inserted into the interior of the DRB 4 before the lid 42 is secured, for example using M6×16 mm hex head set fully threaded screws 44, M6 full nuts 45 and M6 washers 46. This ensures that the PCM/CPCM modules can be checked and, when required, replaced.

In the embodiment shown, the face plate 41 is larger than the openings 35 of the HAC 3, such that when the DRBs 4 are inserted through the openings 35, the face plates 41 abut an outer surface of the sidewalls 32, 32′, and the face plate 41 is fixed on each side panel 32, 32′ of the HAC 3 by screws and nuts.

The DRBs 4 as well as their staggered spacings are shown in FIG. 6. The DRBs 6 have an inner volume of 6.39 L with 290 mm (length)×290 mm (width)×76 mm (height). The area of the face plate 41 is larger than the area of the body 40 to enable fixing. 60 DRBs 4 are arranged in the M-TES container 2 in a staggered pattern to stimulate turbulence that enhances heat transfer between air and walls. FIG. 6C shows the up and down staggered displacement is 47 mm. The gaps between DRBs 4 are respectively 32 mm in row and 39 mm in column. The minimum spacing between DRBs 4 and the end plates of the air channel 33, 34 are respectively 26.5 mm and 17.5 mm. The spacing between DRBs 4 and the first and second sidewalls 30, 31 are 29 mm and 137 mm.

Instrumentation is installed to monitor and control the heat charging and discharging processes quantitatively. Referring to FIGS. 7A to 7C there is shown a temperature measurement setup (FIG. 7A), a pressure and flow rate measurement setup (FIG. 7B) and three types of thermowell connections (FIG. 7C). The temperature, pressure and flow rate are all monitored as the process involves energy transfer and fluid flow. Type-K thermocouples and high-temperature (i.e., >125° C.) pressure transducers are installed in the system for temperature and pressure measurement, respectively. A Venturi tube is used to measure flow rate. One or more PID temperature controllers are used for controlling a heater.

Referring now to FIG. 7A, twelve or more calibrated thermocouples 80 are installed at different locations to take temperature readings and provide temperature feedback for the temperature controllers (see FIG. 7). The thermocouples 80 have a welded connection 81 to a measuring tip 82 and an extension wire 83 for connection to a datalogger or PID temperature controller as feedback.

Observing the temperature at different locations is important, particularly inside the HAC 3.

Temperature feedback at the inlet of the blower is also required to avoid over-heating of the blower 6. Another temperature feedback is located at the heater's outlet to monitor the maximum air temperature generated.

Socket weld thermowells 84 are used for the installation of thermocouples 80 onto the main process lines 85 and to prevent the thermocouples 80 from damage caused by thermal/hydraulic/acceleration stress.

FIG. 7C shows different types, flagged 84a, threaded 84b and welded 84c, of thermowell connections. The welding type thermowells 84c feature the longest unsupported length inside the process line and smallest supporting/gripping area although they are cheaper.

Gems pressure transducers 86 are selected for the pressure measurement. Six such pressure transducers 86 are installed at various locations in the loop. For example, two pressure transducers are located at the Venturi tube 87 for flow rate measurements; one downstream of air cassette heaters outlet; one at the inlet of the blower; one downstream the flow control valve; and the last at the air cassette heaters inlet.

For medium and low temperature systems cooling coils 88 are connected to the pressure transducers 86 via a female G1/4 connector 88a to reduce the temperature of the pressure transducer and to avoid the need for expensive ultra-high-temperature pressure transducers (+400° C.). An interception valve 89a and a bleed valve 89b are installed for pressure transducer installation and calibration.

For high temperature systems additional water cooling may be required.

In use, the pipeline is connected as shown in FIG. 7B. The interception valve 89a is closed, and bleed valve 89b is opened. The pressure transducer 86 is installed. When no pressure is applied, the sensor's reading must be zero (gauge pressure, implying the actual absolute pressure is equal to the ambient pressure), if it does not read zero it must be calibrated and adjusted to zero. The bleed valve 89b is then closed and pressure applied. The interception valve 89a is slowly opened to ensure flow and the pressure readings are recorded by the datalogger.

Referring now to FIG. 8, there is shown an M-TES system 100 in the charging phase. In use, the M-TES system 100 recovers IWH 101, e.g. from furnace flue exhaust, or electrical heat by using cheap electricity in the off-peak time, to charge the PCM/CPCM modules located in the DRBs 4 within the HAC 3. After the charging process, the M-TES container 2 of PCM/CPCM modules is transported to the user sites where the stored heat is discharged to supply heat to local heating systems.

The main components of the M-TES system 100 include: air heater 5, 6-inch diameter stainless steel tubes 102, 102′, 6-inch flexible hose 103, 103′, hot air chamber 3, carrier 7, high temperature blower 6, rectangular to circle converter 104, flow control valve 105 and ambient air inlet 106. The setup 101 comprises component air heater 5 for simulating an IWH source or a renewable heat source site and the components of stainless steel tubes 102, 102′ and measuring equipment, including pressure transducers 86 and thermocouples 80.

FIG. 8 shows the system schematic flow corresponding to the charging phase. During the charging process, the M-TES container 2 containing PCM/CPCM modules is transported to a heat source 101 site, e.g. IWH site, by the carrier 7. The heat carried by a HTF, e.g. hot air, is fed to the HAC 3 to heat the PCM/CPCM modules within the receptacles. The HTF is cooled down, flowing back to the heat source site. A recirculated flow is formed. From node (I) to node (A), the cooled HTF is heated up again by air heater 5, a 24 KW air heater, to a (pre-set) high-temperature level up to 400° C. (in this example). The power of the air heater 5 is controlled by a PID controller to ensure that the temperature does not exceed 400° C. The heated HTF flows through the stainless steel tube 102, to node (B), the connection between the heat source 101 and the M-TES container 2. Through component the flexible hose 103, the heated HTF reaches node (C), the fluid inlet of the HAC 3, and then flows through the HAC 3 along four interconnected channels to node (D), the fluid outlet of the HAC 3. In the process, the heat from the HTF is transferred to the PCM/CPCM modules within the array of DRBs 4. The cooled HTF then leaves node (D), where a flow of ambient air may be introduced from ambient air inlet 106, if temperature is too high at the air blower 6 inlet (node E). The flow of fluid/air is driven by a 4 kW high-temperature air blower 6 between node (E) and node (F) to ensure the pressure of the HTF is sufficient to recirculate in the loop. A flow control valve 105 between node (F) and node (G) controls the HTF flow within a pre-set range with an average of ~200 L/s at standard conditions. The HTF then leaves node (H), flowing through the Venturi tube 87, then flowing through stainless steel tubes 102′ and flexible hose 103′, eventually reaching node (I), the inlet of the air heater 5, to complete the circulation.

FIG. 9 shows the system schematic flow corresponding to the discharging phase. The difference between the setup of the charging phase (FIG. 8) and the discharging phase (FIG. 9) is that the air heater 5 is replaced by the heat user 107. The cooled HTF flows through the stainless steel tubes 102 and flexible hose 103, across nodes (A), (B) and (C), entering the HAC 3 and flowing along the interconnected air channels to the fluid outlet of the HAC 3. Meanwhile, the heat stored in the PCM/CPCM modules within the array of DRBs 4 is transferred to the HTF, increasing the temperature of the HTF to a pre-set temperature when leaving the node (D). The heated HTF then flows through the stainless-steel tubes 106, pressurised by the blower 6 between nodes (E) and (F), and continues flowing from node (F) to node (G) where a flow control valve 105 controls the flow rate, continues flowing through the Venturi tube 87, reaching node (H), then through the stainless steel tubes 102′ and flexible hose 103′, and eventually reaching node (I) the inlet of the heat user 107, where the HTF passes the heat to the end user and complete this circulation.

The discharging time varies with the air flow rate and temperature, as well as the heat demand and temperature of the end user, and the discharging phase stops when the outlet temperature drops below the pre-set end user temperature.

### Modelling

A mathematical model was established for geometrically design of the CPCMs based M-TES system 100 for the optimisation of the operation and assessment of the system-level thermal performance. The main assumptions made for the modelling are as follows: (i) CPCM modules are homogeneous and isotropic in terms of thermophysical properties; (ii) the CPCM modules do not deform during phase change; (iii) the M-TES device is well insulated.

The model only refers to the domains of HAC 3 and CPCMs modules with the receptables. The methodology of three-dimensional modelling transient flow and heat transfer of the M-TES system 100 uses the following governing equations for the air domain with the k-ε model for describing the turbulence flow:

### Continuous Equation:

$$\frac{\partial {ρ}_{g}}{\partial t} + ∇ \cdot ( {ρ}_{g} u ) = 0 \qquad ( 1 )$$

where ρ_{g} represents the density of HTF (air) which is weakly compressible; and u is the air velocity.

### Momentum Equation:

$${ρ}_{g} \frac{\partial u}{\partial t} + {ρ}_{g} ( u \cdot ∇ ) u = ∇ \cdot [ ( {μ}_{g} + {μ}_{T} ) ( ∇ u + {( ∇ u )}^{T} ) - pI - \frac{2}{3} [ ( {μ}_{g} + {μ}_{T} ) ( ∇ \cdot u ) + {ρ}_{g} k ] I ] \qquad ( 2 )$$

where μ_{g} and μ_{T} represent respectively the dynamic viscosity of air and the eddy viscosity; μ_{T} is given by the k-ε model with k and & being the turbulent kinetic energy and dissipation rate, respectively (see below).

### Energy Equation:

$${ρ}_{g} {c}_{pg} \frac{\partial {T}_{g}}{\partial t} + {ρ}_{g} {c}_{pg} u \cdot ∇ {T}_{g} + ∇ \cdot ( - {λ}_{g} ∇ {T}_{g} ) = 0 \qquad ( 3 )$$

where T_{g} represents temperature of air; c_{pg}, and λ_{g} represent the constant pressure heat capacity, and thermal conductivity of air, respectively, which are function of temperature. The above equations are not closed, which require additional equations as follows: k-ε model:

$${ρ}_{g} \frac{\partial k}{\partial t} + {ρ}_{g} ( u \cdot ∇ ) k = ∇ \cdot [ ( {μ}_{g} + \frac{{μ}_{T}}{{σ}_{k}} ) ∇ k ] + {P}_{k} - {ρ}_{g} ε \qquad ( 4 )$$

$${ρ}_{g} \frac{\partial ε}{\partial t} + {ρ}_{g} ( u \cdot ∇ ) ε = ∇ \cdot [ ( {μ}_{g} + \frac{{μ}_{T}}{{σ}_{ε}} ) ∇ ε ] + {C}_{1 ε} \frac{ε}{k} {P}_{k} - {C}_{2 ε} {ρ}_{g} \frac{{ε}^{2}}{k} \qquad ( 5 )$$

$${μ}_{T} = {ρ}_{g} {C}_{μ} \frac{{k}^{2}}{ε} \qquad ( 6 )$$

In Equations (4)-(6), C_{μ}, σₖ, σ_{ε}, C_{1ε}, and C_{2ε} are given respectively as 0.09, 1.00, 1.30, 1.44, 1.92.

For the domain of CPCM modules, only energy equation is involved due to non-deformation:

$${ρ}_{s} {c}_{ps} \frac{\partial {T}_{s}}{\partial t} + ∇ \cdot ( - {λ}_{s} ∇ {T}_{s} ) = 0 \qquad ( 7 )$$

where Tₛ is the temperature of CPCM modules; ρₛ, cₚₛ, and λₛ represent respectively the density, effective constant-pressure specific heat, and effective thermal conductivity of CPCM modules.

The thermophysical properties of air including density, dynamic viscosity, specific heat, thermal conductivity, are fitted as polynomial functions of temperature⁵.

The effective thermal conductivity of the CPCM modules (made of a phase change material, PCM; a thermal conductivity enhancement material, TCEM; and a ceramic skeleton material, CSM) is modelled by the following two models.

The Maxwell model is used for the PCM/TCEM mixture:

$$\frac{{λ}_{e}}{{λ}_{PCM}} = \frac{{λ}_{TCEM} + 2 {λ}_{PCM} - 2 ϕ ( {λ}_{PCM} - {λ}_{TCEM} )}{{λ}_{TCEM} + 2 {λ}_{PCM} + ϕ ( {λ}_{PCM} - {λ}_{TCEM} )} \qquad ( 8 )$$

where λ_{PCM} and λ_{TCEM} are respectively the thermal conductivities of PCM and TCEM; λₑ is the effective thermal conductivity of the PCM/TCEM mixture; φ is the volume fraction of TCEM in the mixture.

The Zehner-Schlunder's model is used to estimate the effective thermal conductivity of the CPCM modules, λ_{CPCM}:

$$\frac{{λ}_{s}}{{λ}_{e}} = 1 - \sqrt{1 - ψ} + \frac{2 \sqrt{1 - ψ}}{1 - Λ B} ( \frac{( 1 - Λ ) B}{{( 1 - Λ B )}^{2}} ln \frac{1}{Λ B} + \frac{B + 1}{2} - \frac{B - 1}{1 - Λ B} ) \qquad ( 9 )$$

where ∧ is the ratio of thermal conductivities of the PCM/TCEM mixture to the CSM, λₑ/λ_{CSM}; B stands for the shape factor determined as follows:

$$B = {γ ( \frac{1 - ψ}{ψ} )}^{a} \qquad ( 10 )$$

where y and a are constants taken as 1.364 and 1.055, respectively; ψ is initially defined as the porosity of CSM, but is treated as the volume fraction of the PCM/TCEM mixture in the CPCMs here.

The effective specific heat of the CPCM modules, cₚₛ, is a function of temperature as follows:

$$\{ \begin{matrix}{c}_{p , CPCM} & T \leq ( {T}_{pc} - \frac{Δ {T}_{l - s}}{2} ) or T > ( {T}_{pc} + \frac{Δ {T}_{l - s}}{2} ) ; \\ {c}_{p , CPCM} + \frac{2 Δ {h}_{pc} ( 2 T - 2 {T}_{pc} + Δ {T}_{l - s} )}{Δ {T}_{l - s}^{2}} & ( {T}_{pc} - \frac{Δ {T}_{l - s}}{2} ) < T \leq {T}_{pc} ; \\ {c}_{p , CPCM} + \frac{2 Δ {h}_{pc} ( 2 {T}_{pc} + Δ {T}_{l - s} - 2 T )}{Δ {T}_{l - s}^{2}} & {T}_{pc} < T \leq ( {T}_{pc} + \frac{Δ {T}_{l - s}}{2} ) ;\end{matrix} \qquad ( 11 )$$

where T_{pc} and Δh_{pc} represent the phase change temperature and the latent heat of the PCM; ΔTᵢ₋ₛ is the temperature transition interval of the phase change process which is set as 6 K in this study; c_{p,CPCM} is calculated by:

$${ρ}_{s} {c}_{p , CPCM} = ( 1 - ψ ) {ρ}_{CSM} {c}_{p , CSM} + ψ [ ( 1 - ϕ ) {ρ}_{PCM} {c}_{p , PCM} + ϕ {ρ}_{TCEM} {c}_{p , TCEM} ] \qquad ( 12 )$$

$${ρ}_{s} = ( 1 - ψ ) {ρ}_{CSM} + ψ [ ( 1 - ϕ ) {ρ}_{PCM} + ϕ {ρ}_{TCEM} ] \qquad ( 13 )$$

where ρₛ is the effective density of the CPCM modules determined by the densities of CSM, TCEM and PCM and their respective volume fractions.

The above equations were solved in the Comsol Multiphysics 6.0 environment. The built-in CAD and Mesh tools were used for the drawing and meshing work. Grid dependency was investigated, and the final computational grid consisted of 3×10⁵ unstructured cells. The governing Equations 1-7 were discretized and solved in the Comsol solver with the BDF (backward differentiation formula) method for time stepping. The P1+P1 method (P1: first order element) was used for the discretization of velocity components, turbulent kinetic energy and dissipation rate, and the pressure field, while the linear method is for temperature field. The time-step size was adjusted to maintain the relative tolerance of 10⁻³. In every time step, the algebraic equations were solved by a Segregated solver with a damped Newton solver. The resulting linear equations for the fluid flow and heat transfer were solved by means of direct solvers, MUMPS and PARDISO.

FIG. 10A shows the change of heating powers during charging and discharging processes. During the charging phase, the inlet air flow rate was 200 L/s. The initial charging power was 20 KW as the air heater ran at full capacity. After 2 hours, the charging power began to decrease for controlling the outlet temperature and eventually dropped to 6 KW. During the discharging phase, the inlet flow rate was 50 L/s. The initial discharging power was 18 KW which decreased over time and dropped to 1.2 KW after 6 hours.

FIGS. 10B and 10C show the evolution of thermal energy over time in charging and discharging phases and the proportion of the released heat to the total stored thermal energy during discharging. The thermal energy is calculated with reference to the ambient temperature. One can see over 300 MJ stored heat in the M-TES system after charging for 6 hours. More than 85% of this stored heat can be released after discharging within 6 hours.

FIG. 11A shows how the average temperatures, in different locations, change during charging and discharging. For the charging phase, the air inlet temperature (Line 200) starts at 170° C., rises to 400° C. in 2 hours and then remains unchanged. The temperature in three different locations of the TES container, i.e. the 1^{st} (Line 201), 10^{th} (Line 202), and 20th (Line 203) columns of the array of CPCM modules, are provided. The finial temperatures are 400° C., 370° C., 310° C., respectively, at the end of charge. For the discharging phase, the air out temperature (Line 204) starts at 350° C. and then gradually decreases over time. The outlet temperature is still above 100° C. after 6 hours of discharge. Meanwhile, the average temperature in the 1^{st} (Line 201), 10th (Line 202), and 20^{th} (Line 203) columns of the array of CPCM modules decreases to 25° C., 70° C., 140° C., respectively.

FIG. 11B shows the temperature difference between the centre (dotted lines 201′, 202′, 203′) and the surface (starred lines 201″, 202″, 203″) of the middle modules in the 1^{st} (Line 201′ 201″), 10^{th} (Line 202′ 202″), and 20^{th} (Line 203′ 203″) columns. Even though, the maximum difference appears during the phase changing process which may exceed 170° C., it is at a low level in most of the time, less than 30° C. and 35° C. at the end of charge and discharge phases, indicating that the PCM modules have a good temperature uniformity.

FIG. 11C shows an array of detachable rectangular boxes (i.e. receptacles) comprising PCM/CPCM modules (not shown), arranged in a container. The detachable regular boxes are grouped together into sets or ‘columns’. There is shown the 1^{st} (C1), 5^{th} (C5), 10^{th} (C10), 15^{th} (C15), 20^{th} (C20) columns.

The present modelling is based on a PCM of NaNO₃, a 20 KW heating power, and constant inlet flow rates of 200 L/s (charging) and 50 L/s (discharging).

It will be appreciated by those skilled in the art that any number of combinations of the aforementioned features and/or those shown in the appended drawings provide clear advantages over the prior art and are therefore within the scope of the invention described herein.

1. A thermal energy storage container comprising a chamber defined by at least one sidewall, a first end plate and a second end plate, the chamber comprising: at least one fluid inlet, at least one fluid outlet, a flow path for the transport of a heat transfer fluid from the fluid inlet to the fluid outlet, and a support configured to support a receptacle within the flow path and enable direct contact between the heat transfer fluid and a surface of the receptacle, wherein the receptacle has composite phase change material (CPCM) located therein, the CPCM comprising structural material providing a supporting structure for shape stabilisation of the CPCM.

2. The thermal energy storage container according to claim 1, comprising a plurality of supports configured to support a plurality of receptacles within the flow path and enable direct contact between the heat transfer fluid and a surface of each receptacle.

3. The thermal energy storage container according to claim 1, wherein the heat transfer fluid is a gas, e.g. air.

4. The thermal energy storage container according to claim 1, wherein the chamber comprises one or more baffles defining a plurality of interconnected channels which are arranged in series to form the flow path and/or wherein the chamber comprises two baffles which are arranged perpendicular to one another, so as to divide the chamber into four channels.

5. (canceled)

6. (canceled)

7. The thermal energy storage container according to claim 1, wherein the or each support is configured to enable direct contact between the heat transfer fluid and at least 2, 3, 4 or 5 surfaces of the or each receptacle, when received in the chamber and/or to enable direct contact between the heat transfer fluid and at least 20% of the surface area of the or each receptacle, e.g. at least 20, 25, 30, 35, 40, 45, 50, 55, 60, 65, 70, 75, 80, 85, 90 or at least 95% of the surface area of the or each receptacle.

8. (canceled)

9. The thermal energy storage container according to claim 2, wherein the supports are configured such that the receptacles, when received in the chamber, are arranged in a staggered configuration and are spaced apart from: each other, one or more of the sidewall(s), the first end plate and/or the second end plate of the chamber.

10. The thermal energy storage container according to claim 1, wherein the or each support comprises a bar.

11. (canceled)

12. The thermal energy storage container according claim 2, wherein the supports are configured such that the receptacles, when present, are distributed substantially evenly within the flow path.

13. The thermal energy storage container according to claim 1, wherein one or more of the sidewall(s) of the chamber comprises a plurality of openings for receiving the or each receptacle therein.

14. A receptacle for containing a material for thermal energy storage, the receptacle comprising a body, wherein a side or end portion of the body comprises a flange for securing the receptacle to a chamber, wherein the receptacle has composite phase change material (CPCM) located therein, the CPCM comprising structural material providing a supporting structure for shape stabilisation of the CPCM.

15. The receptacle according to claim 14, comprising a lid, wherein the lid is openable to allow access to the interior of the receptacle.

16. The receptacle according to claim 14, wherein the receptacle contains a graphite powder which coats at least a portion of an interior surface of the receptacle.

17. (canceled)

18. The receptacle according to claim 14, wherein the composite phase change material comprises a phase change material, a structural material and a thermal conductivity enhancer material.

19. The receptacle according to any of claim 18, wherein the structural material is selected from: heavy magnesium oxide, light magnesium oxide, silica, alumina, vermiculite, diatomite or other suitable structural materials or combinations thereof and/or wherein the thermal conductivity enhancer material is an organic or an inorganic compound with high thermal conductivity and thermal stability in the operating temperature range, e.g. the thermal enhancer material is expanded graphite.

20. (canceled)

21. The receptacle according to claim 14, wherein the CPCM is in the form of a module.

22. The receptacle according to claim 21, wherein the module is wrapped in a foil, e.g. stainless steel or aluminium foil, optionally wherein a surface of the foil is at least partially coated with graphite powder.

23. A thermal energy storage system for storing, transporting and utilising renewable heat, waste heat or heat produced with off-peak electricity, the thermal energy storage system comprising a thermal energy storage container comprising a chamber defined by at least one sidewall, a first end plate and a second end plate, the chamber comprising: at least one fluid inlet, at least one fluid outlet, a flow path for the transport of a heat transfer fluid from the fluid inlet to the fluid outlet, and a support configured to support a receptacle within the flow path and enable direct contact between the heat transfer fluid and a surface of the receptacle, wherein the receptacle has composite phase change material (CPCM) located therein, the CPCM comprising structural material providing a supporting structure for shape stabilisation of the CPCM.

24. (canceled)

25. (canceled)

26. (canceled)

27. The thermal energy storage system according to claim 23, further comprising one or more heat exchangers for charging and/or discharging heat transfer fluid, to and/or from the thermal energy storage container, in use.

28. (canceled)

29. (canceled)

30. The thermal energy storage system according to claim 23, further comprising one or more flowmeters and/or one or more thermocouples and/or one or more temperature and/or pressure controllers, and/or one or more pressure transducers, for monitoring and/or controlling the flow rate and/or temperature and/or pressure of the system and/or a blower and/or a high-temperature air blower.

31. (canceled)

32. (canceled)

33. The thermal energy storage system according to claim 23, further comprising a carrier for transporting the components of the thermal energy storage system or the components of a plurality of thermal energy storage systems.

34. A method of charging a thermal energy storage system, the method comprising:
a) providing a thermal energy storage system according to claim 23, wherein the chamber of the thermal energy storage container contains a receptacle or a plurality of receptacles, said receptacle or each of said plurality of receptacles comprising a body, wherein a side or end portion of the body comprises a flange for securing the receptacle to a chamber, wherein the receptacle has composite phase change material (CPCM) located therein, the CPCM comprising structural material providing a supporting structure for shape stabilisation of the CPCM, the receptacle having a thermal energy storage material located therein;
b) flowing a pre-heated heat transfer fluid through the fluid inlet of the chamber, along the flow path and out of the fluid outlet, such that heat transfer takes place from the heat transfer fluid to the receptacle(s), thereby charging the material therein.

35. The method of claim 34, wherein the heat transfer fluid is a gas, such as air, wherein the method further comprises heating the heat transfer fluid to obtain the pre-heated heat transfer fluid by a heat source selected from heat source site including an industrial waste heat (IWH) site, a renewable energy source site, or a heater, e.g. an electrical heater powered by off-peak/excess electricity.

36. (canceled)

37. (canceled)

38. The method of claim 35, the method further comprising transporting the heat transfer fluid from the fluid outlet back to the heat source and cooling the heat transfer fluid as it is transported from the fluid outlet to the heat source and/or transporting the thermal energy storage system to an end user site after charging the thermal energy storage material.

39. (canceled)

40. (canceled)

41. (canceled)

42. A method of discharging a thermal energy storage system, the method comprising:
a) providing a thermal energy storage system according to claim 23, wherein the chamber of the thermal energy storage container contains a receptacle or a plurality of receptacles, said receptacle or each said plurality of receptacles comprising a body, wherein a side or end portion of the body comprises a flange for securing the receptacle to a chamber, wherein the receptacle has composite phase change material (CPCM) located therein, the CPCM comprising structural material providing a supporting structure for shape stabilisation of the CPCM, the receptacle having a charged thermal energy storage material located therein;
b) flowing a heat transfer fluid through the fluid inlet of the chamber, along the flow path and out of the fluid outlet, such that heat transfer takes place from the receptacle(s) to the heat transfer fluid, thereby discharging the material therein.

43. The method of claim 42, further comprising transporting the heated heat transfer fluid from the fluid outlet to an end user.

44. (canceled)
